(19) United States
(12) Patent Application Publication
(10) Pub. No.: US 2010/0245362 A1
(43) Pub. Date: Sep. 30, 2010

(54) Method for adjusting strokes of font

(76) Inventors: Yi-Hui Huang, Taipei City (TW); Fu-Sheng Wu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 12/479,837

(22) Filed: Jun. 7, 2009

(30) Foreign Application Priority Data
Mar. 24, 2009 (TW) 098109609

(51) Int. Cl. G06T 11/00

(52) U.S. Cl. 345/467

(57) ABSTRACT

A method of adjusting strokes of a font is provided for scaling a complex font to improve the strokes appearing visually blurry. When generating a font, a font engine firstly calculates the insufficient spaces units between two adjacent strokes of the font according to the stroke data of the font. Then, the font engine obtains the fine-tune information of the font, and calculates the optimum distribution of the strokes according to the insufficient spaces units and the fine-tune information so as to generate the stroke-tuning values of the font. Finally, the character is outputted according to the stroke data and the stroke-tuning values of the font.

### BACKGROUND OF THE INVENTION

1. Field of the Invention

The present invention relates to a method for generating a font, and more particularly, to a method for adjusting strokes of a font.

2. Description of the Prior Art

When the font is scaled to a smaller size, it is possible that certain strokes, which meant to be separated, of the scaled font are consequently jumbled together due to the scaled space limitation; causing blurry appearance of the scaled font and the visual quality of the scaled font is accordingly deteriorated. The conventional font scaling technology mainly serves European-fonts, e.g. TrueType fonts, and because the alphabetic quantity of the European language is relatively limited so every alphabetical character can be extremely fine-tuned to generate fonts with high visual quality. However, such method is not particularly applicable to the Kanji fonts due to the complexity of the Kanji language system, as not only a lot of manual efforts are required but also the overall fine-tuning data for all the Kanji fonts is too impractical to be implemented into an embedded system.

Please refer to FIG. 1. FIG. 1 is a flowchart of the method of the conventional technology for generating a font. The steps are described as follows:

Step 110: Provide stroke data of a font, wherein the stroke data comprises stroke IDs and start positions of each stroke of the font;

Step 120: Output a stroke of the font;

Step 130: Determine if all strokes of the font are outputted; if so, go to step 150; if not, go to step 140;

Step 140: Generate strokes according to the stroke data of the font, and then go to step 120;

Step 150: Complete outputting the font.

Please refer to FIG. 2. FIG. 2 is a diagram illustrating the strokes being jumbled together when the conventional font-scaling technology scales the font. The font 200 comprises six horizontal strokes 1 to 6. When the font 200 is scaled as illustrated, because of the limitation of the available space, certain adjacent strokes of the font 200 are jumbled together (e.g. strokes 2 & 3 are cluttered together in the 16×16 space), which causes the scaled font 200 to be blurry. For fonts with a more complicated structure (i.e. fonts that consist of a higher number of strokes), the situation where the strokes of the font being jumbled together and the font being blurry becomes more problematic as the font is scaled smaller. On the other hand, when the font is scaled larger, the width of each strokes of the font becomes wider and occupies more space accordingly. Therefore, the situation where the strokes are cluttered together still exists due to insufficient space. When the size of the font 200 is 12×12, there are three clusters that the horizontal strokes of the font are cluttered together (i.e. strokes 1 & 2, strokes 2 & 3, and strokes 4 & 5); when the size of the font 200 is 13×13, there are two clusters that the horizontal strokes of the font are cluttered together (i.e. strokes 1 & 2, and strokes 3 & 4); when the size of the font 200 is 14×14, there is one cluster that the horizontal strokes of the font are cluttered together (i.e. strokes 2 & 3); when the size of the font 200 is 15×15, there is one cluster that the horizontal strokes of the font are cluttered together (i.e. strokes 4 & 5); when the size of the font 200 is 16×16, there is one cluster that the horizontal strokes of the font are cluttered together (i.e. strokes 2 & 3).

Therefore, it is obvious from the description above that because of the limitation of the available space, the strokes of one font are likely to be jumbled when the font is scaled to the size such as 12×12 or 16×16 by the conventional font-scaling technology, which causes the font to appear blurry and the visual quality of the font is deteriorated, consequently causing reading inconvenience.

### SUMMARY OF THE INVENTION

The present invention provides a method for fine-tuning strokes of a font. The method comprises providing stroke data of the font, calculating insufficient space between two adjacent strokes of the font according to the stroke data, obtaining fine-tune information of the font, calculating optimum space distribution according to the insufficient space and the fine-tune information for generating stroke-tuning values of the font, and outputting the font according to the stroke data and the stroke-tuning values.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of the method of the conventional technology for generating a font.

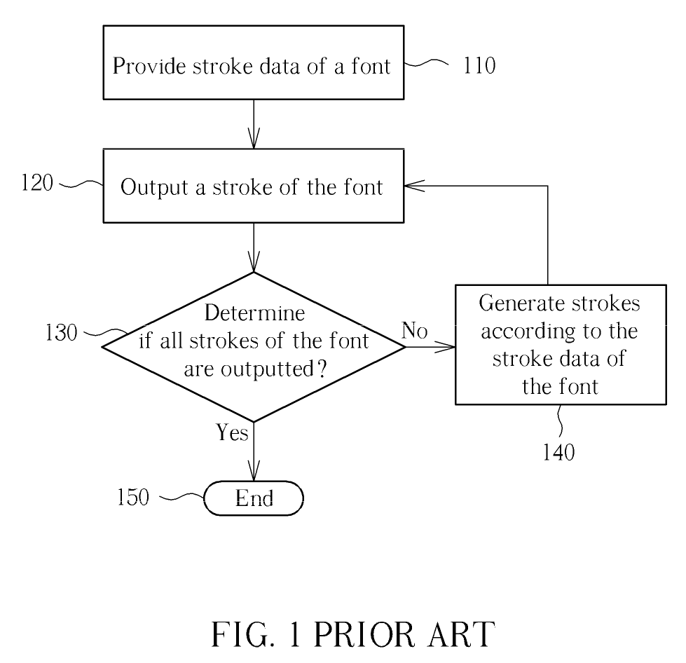

FIG. 2 is a diagram illustrating the strokes being jumbled together when the conventional font-scaling technology scales the font.

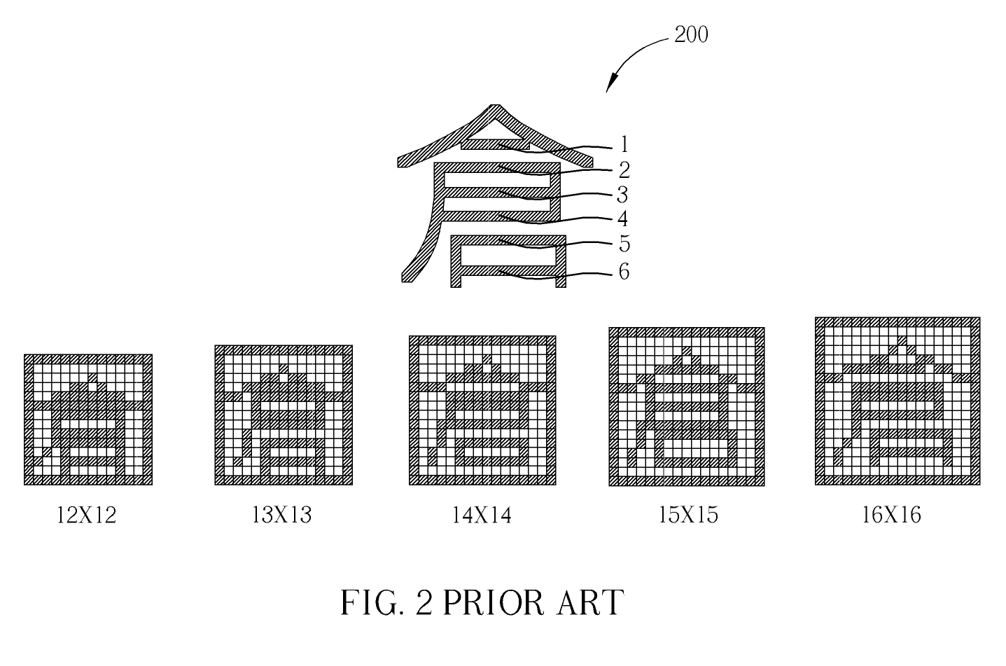

FIG. 3 is a flowchart illustrating the method for fine-tuning strokes of a font according to the present invention.

FIG. 4 is a diagram illustrating the stroke data of the font.

FIG. 5 is a diagram illustrating the font being scaled to 12×12 by the conventional method and the present invention.

FIG. 6 is a diagram illustrating the comparison of stroke-tuning values of the horizontal strokes of the font between the conventional method and the present invention.

FIG. 7 is a diagram illustrating the comparison of the positions of the horizontal strokes of the font being scaled to 12×12 and 256×256.

FIG. 8 is a flowchart illustrating the horizontal strokes of a font being divided into different divisions when the method for adjusting strokes of the font of the present invention is executed.

FIG. 9 is a diagram illustrating one embodiment that the horizontal strokes of a font are divided into different divisions when the method for adjusting the strokes of the font of the present invention is executed.

FIG. 10 is a diagram illustrating an exemplary embodiment of the stroke-simplifying rule.

FIG. 11 is a diagram illustrating various types of fonts.

FIG. 12 is a diagram illustrating the method for adjusting strokes of a font of the present invention when the font is defined as a non-stroke-composition font.

### DETAILED DESCRIPTION

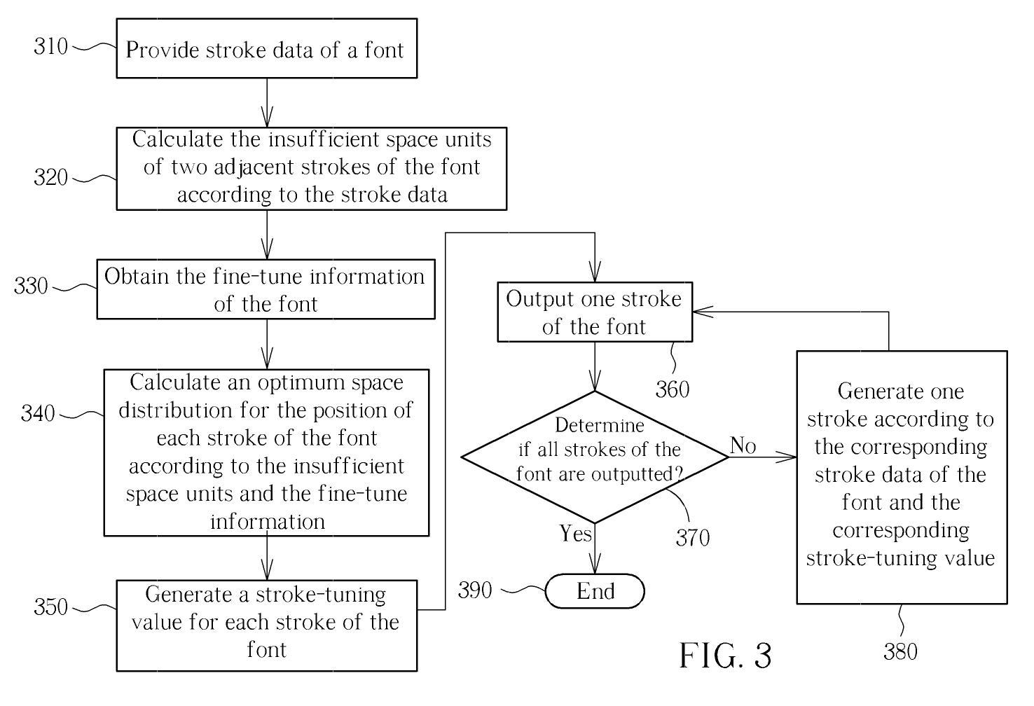

Please refer to FIG. 3. FIG. 3 is a flowchart illustrating the method for fine-tuning strokes of a font according to the present invention. In the present invention, it is assumed that a font comprises a plurality of strokes and a corresponding stroke data, and the stroke data comprises stroke IDs and start positions of each stroke of the font. The present invention further supplements the stroke data of the font with the corresponding fine-tune information. In this way, when the font engine generates the font according to the stroke data, the font engine can further adjust/fine-tune the position and the size of each stroke of the font so that a scaled font, even consists of complex strokes, does not become blurry because of the cluttered strokes and high visual quality of the font can still be achieved even after being scaled by the font engine. The method for adjusting/fine-tuning strokes a font according to the present invention comprises the following steps:

Step 310: Provide a stroke data of a font, wherein the stroke data comprises stroke IDs and start positions of each stroke of the font;

Step 320: Calculate the insufficient space units of each two adjacent strokes of the font according to the stroke data, wherein the two adjacent strokes may be two adjacent horizontal strokes or two adjacent vertical strokes, and when the two adjacent strokes are cluttered together, it means one space unit is deficient between the two adjacent strokes;

Step 330: Obtain the fine-tune information of the font, wherein the fine-tune information stores the fine-tune instructions used by the font, for example, the fine-tune instruction “merge” combines two strokes, the fine-tune instruction “delete” deletes one stroke, which generates two space units; the fine-tune instruction “move down” moves a stroke downwards which generates one space units, and the fine-tune instruction “move up” moves a stroke upwards, which also generates one space units;

Step 340: Calculate an optimum space distribution for the position of each stroke of the font according to the insufficient space units and the fine-tune information;

Step 350: Generate a stroke-tuning value for each stroke of the font;

Step 360: Output one stroke of the font;

Step 370: Determine if all strokes of the font are outputted; if so, go to step 390; if not, go to step 380;

Step 380: Generate one stroke according to the corresponding stroke data of the font and the corresponding stroke-tuning value, and then go to step 360;

Step 390: Complete outputting the font.

According to the step 310, the stroke data of the font comprises stroke IDs and start positions of each stroke of the font. When the font engine generates the font according to the stroke data of the font, the font engine obtains the stroke data of the font according to the sequence of which the font is being outputted, as illustrated in the following table:

| | | | | |
|---|---|---|---|---|
| 1^{st} font | stroke ID + start | stroke ID + | . . . | stroke ID + start |
| | position for | start position | | position for S1^{th} |
| | 1^{st} stroke | for 2^{nd} stroke | | stroke |
| 2^{nd} font | stroke ID + start | stroke ID + | . . . | stroke ID + start |
| | position for 1^{st} | start position | | position for S2^{th} |
| | stroke | for 2^{nd} stroke | | stroke |
| . . . | | | | |
| N^{th} font | stroke ID + start | stroke ID + | . . . | stroke ID + start |
| | position for 1^{st} | start position | | position for SN^{th} |
| | stroke | for 2^{nd} stroke | | stroke |

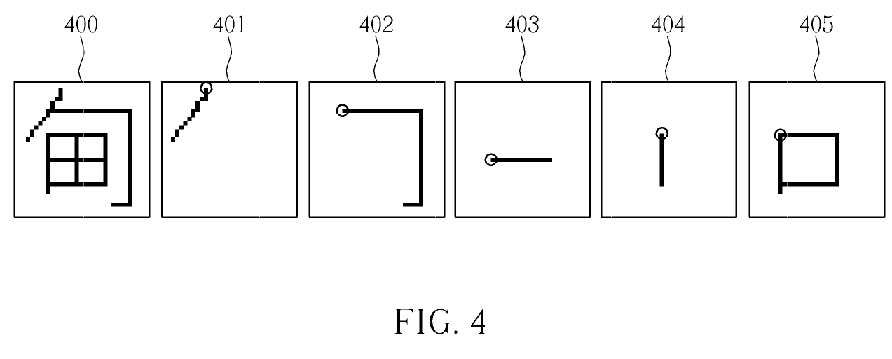

Please refer to FIG. 4. FIG. 4 is a diagram illustrating the stroke data of the font 400. As shown in FIG. 4, the font 400 comprises sequential strokes 401 to 405 and the circle represents the start position of each stroke. The stroke data of the font 400 is shown in the following table:

| Font 400 | Stroke ID | Start position |
|---|---|---|
| 1^{st} stroke 401 | 612 | (72, 11) |
| 2^{nd} stroke 402 | 7661 | (52, 55) |
| 3^{rd} stroke 403 | 3 | (52, 132) |
| 4^{th} stroke 404 | 90 | (108, 94) |
| 5^{th} stroke 405 | 2337 | (52, 94) |

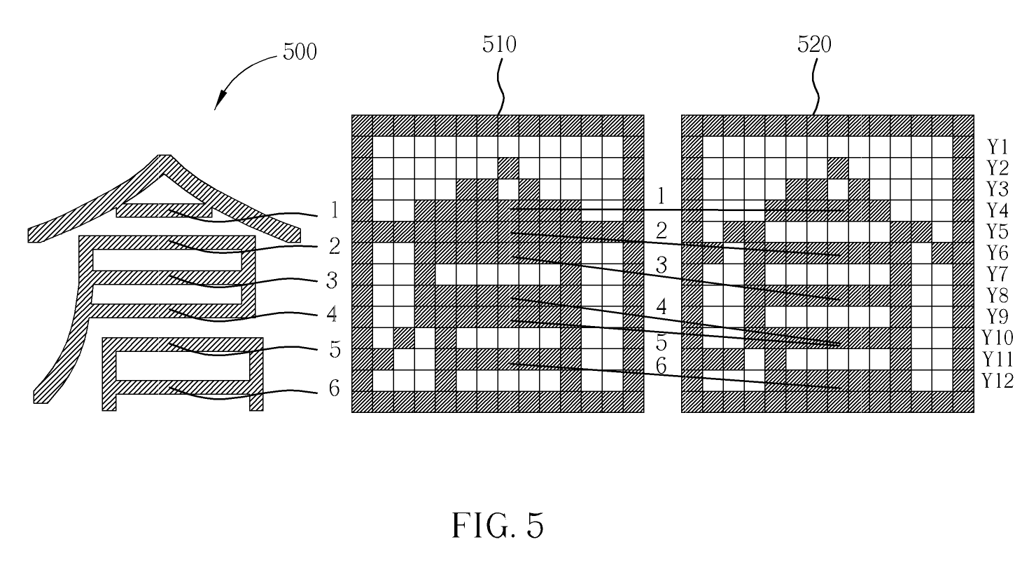

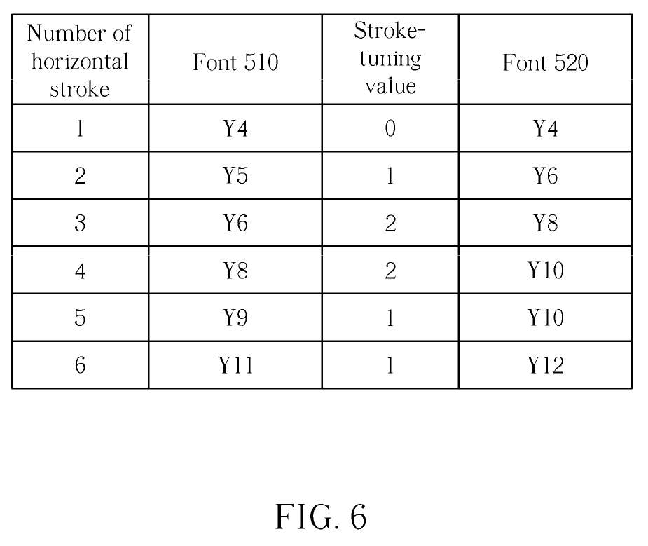

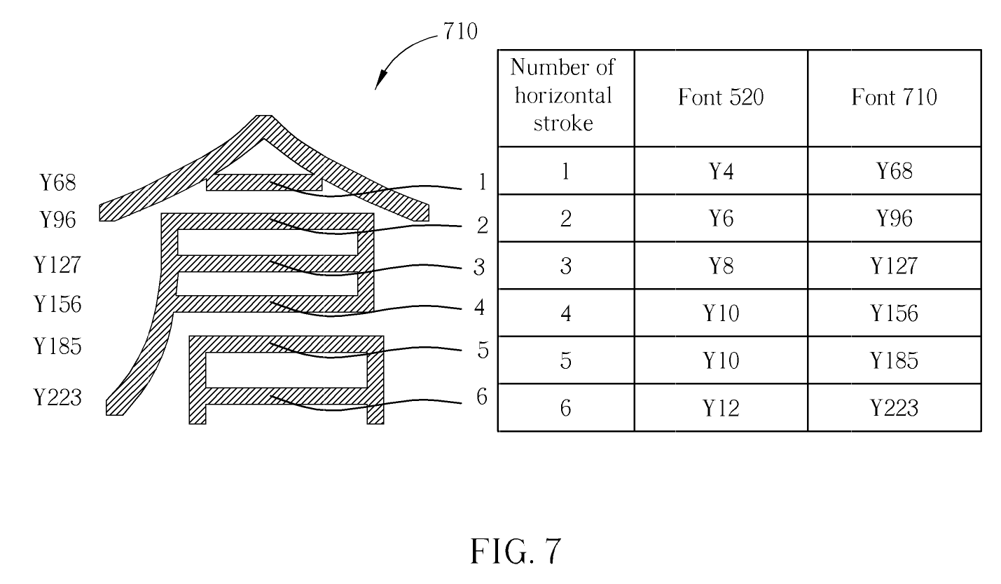

Please refer to FIG. 5, FIG. 6, and FIG. 7. FIG. 5 is a diagram illustrating the font 500 being scaled to 12×12 by the conventional method and the present invention. FIG. 6 is a diagram illustrating the comparison of stroke-tuning values of the horizontal strokes of the font 500 between the conventional method and the present invention. FIG. 7 is a diagram illustrating the comparison of the positions of the horizontal strokes of the font 500 being scaled to 12×12 (font 520) and 256×256 (font 710). In the embodiment illustrated from FIG. 5 to FIG. 7, the font 500 is taken as an exemplary embodiment for illustrating the method for fine-tuning strokes of a font according to the present invention. As shown in FIG. 5, the font 510 represents the font 500 as being scaled to 12×12 by the conventional method, and the font 520 represents the font as being scaled to 12×12 by the method of the present invention. It is obvious that the font 520 appears to be less visually blurry as the cluttered horizontal strokes 1, 2, and 3, and the cluttered horizontal strokes 4 and 5 of the font 510 are now separated. According to the step 320, when the positions of two adjacent horizontal strokes are cluttered together, it means one space unit is deficient between the two adjacent strokes, therefore it is determined that the horizontal strokes 1, 2, and 3 of the font 510 are cluttered together, and the horizontal strokes 4 and 5 of the font 510 are cluttered together, indicating three space units are deficient between the cluttered strokes (i.e. one space unit is deficient between the cluttered horizontal strokes 1 & 2, one space unit is deficient between the cluttered horizontal strokes 2 & 3, and one space unit is deficient between the cluttered horizontal strokes 4 & 5). Furthermore, according to the step 330, the fine-tune information for the font 500 comprises the fine-tune instruction “move down”, the fine-tune instruction “move up”, and the fine-tune instruction “merge”. Accordingly, the horizontal strokes 4 and 5 can be combined into one horizontal stroke by the fine-tune instruction “merge” for generating two space units (the stroke-simplifying rule will be described later). Additionally, the horizontal stroke 6 is moved downwards by the fine-tune instruction “move down” for generating one space unit. As a result, the font 510 has generated deficient three space units by utilizing the fine-tune instructions “merge” and “move down”.

According to the steps 340 and 350, the optimum space distribution for the horizontal strokes 1 to 6 is calculated. As shown in FIG. 6, compare to font 510 of the conventional method, the font 520 of the present invention optimizes the space distribution as below; the horizontal stroke 1 remains at the position Y4, the horizontal stroke 2 is moved from the position Y5 to Y6, the horizontal stroke 3 is moved from the position Y6 to Y8, the horizontal stroke 4 is moved from the position Y8 to Y10, the horizontal stroke 5 is moved from the position Y9 to Y10, and the horizontal stroke 6 is moved from the position Y11 to Y12. Thus, the stroke-tuning values for the font 520 are (0, 1, 2, 2, 1, 1). According to the steps of 360 to 390, the font engine outputs the font 520 according to the stroke data and the stroke-tuning values of the font 510. Furthermore, as shown in FIG. 7, the horizontal strokes 1 to 6 of the font 500 (which is equivalent to the font 710 with resolution of 256×256) are fine-tuned to the corresponding positions of the font 520 by the method of the present invention, and the other strokes of the font 500 can be fine-tuned to the correspond positions of the font 520 according to the relation between the fine-tuned stroke positions of the font 520 and the stroke positions of the font 710. For example, the strokes at the positions Y156 to Y185 of the font 710 are fine-tuned to the position Y10 when scaled to the font 520.

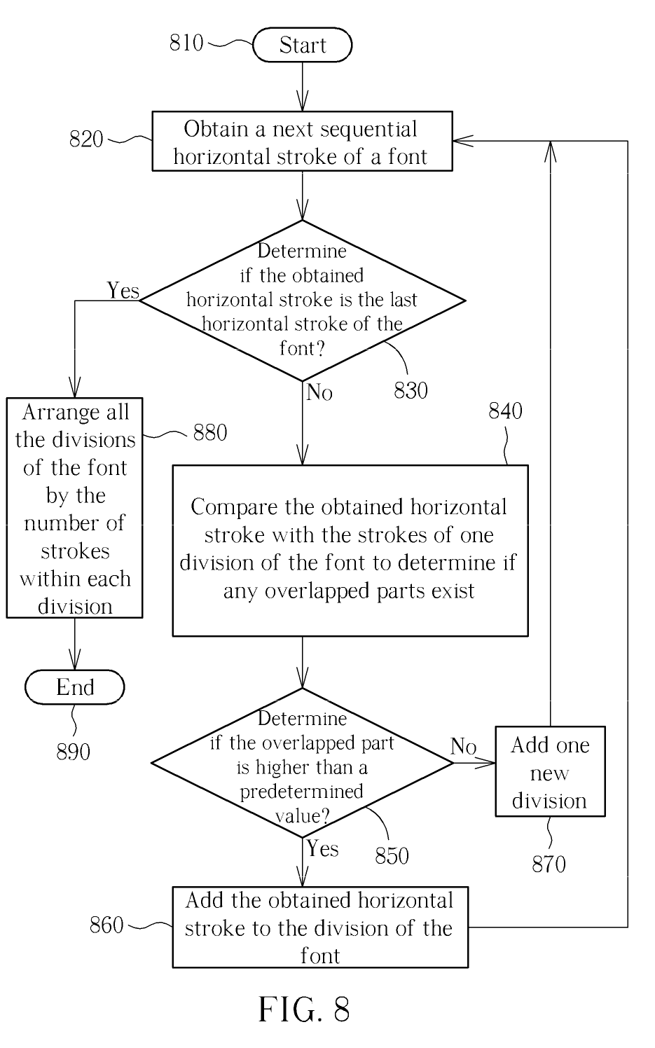

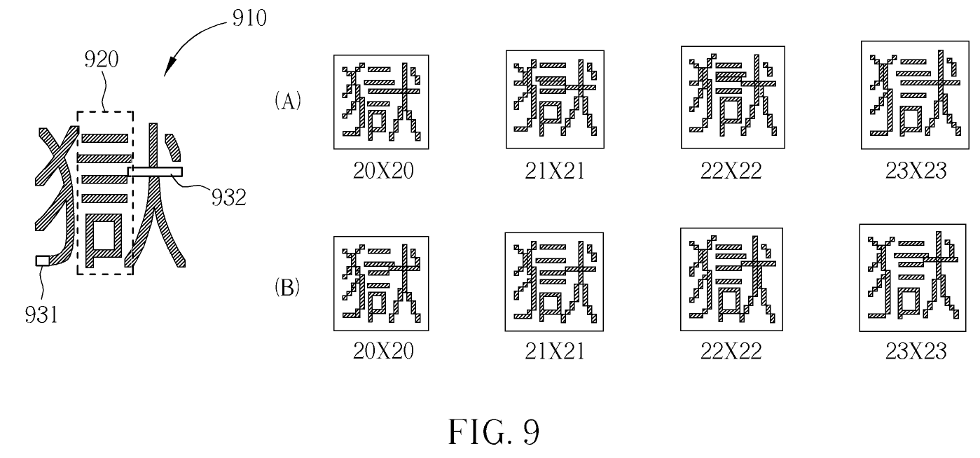

Please refer to FIG. 8 and FIG. 9. FIG. 8 is a flowchart illustrating the horizontal strokes of a font being divided into different divisions when the method for adjusting strokes of the font of the present invention is executed. FIG. 9 is a diagram illustrating one embodiment that the horizontal strokes of a font are divided into different divisions when the method for adjusting the strokes of the font of the present invention is executed. As shown in FIG. 9, horizontal strokes of the radical 920 of the font 910 need to be fine-tuned the most as radical 920 consists of the most horizontal strokes. However, if the horizontal strokes 931 and 932 are adjusted along with the radical 920, interference arises between the horizontal strokes 931 and 932 and the radical 920, as the part (A) shows. Therefore, the method for adjusting/fine-tuning strokes of the font of the present invention can further comprises the following steps for avoiding the interference:

Step 810: Start;

Step 820: Obtain a next sequential horizontal stroke of a font;

Step 830: Determine if the obtained horizontal stroke is the last sequential horizontal stroke of the font;

Step 840: Compare the obtained horizontal stroke with the strokes of one division of the font to determine if any overlapping parts exist;

Step 850: Determine if the overlapped part is higher than a predetermined value; if so, go to step 860; if not, go to step 870;

Step 860: Add the obtained horizontal stroke to the division of the font;

Step 870: Add one new division;

Step 880: Arrange all the divisions of the font by the number of strokes within each division;

Step 890: End.

According to the step 840, the horizontal strokes of the radical 920 forms a first division. Since the horizontal stroke 931 is not overlapped with the horizontal strokes of the first division (i.e. the overlapped part is smaller than a predetermined value), a second division is established. Additionally, since the horizontal stroke 932 is overlapped with the horizontal strokes of the first division, but the overlapped part is smaller than the predetermined value, a third division is established. Thus, the horizontal strokes of the font 910 are divided into three divisions for processing. Consequently, the horizontal strokes of the radical 920 are not fine-tuned along with the horizontal strokes 931 and 932 as the radical 920, the horizontal strokes 931 and 932 all belong to different divisions. In this way, better stroke fine-tuning is achieved, as illustrated in the part (B).

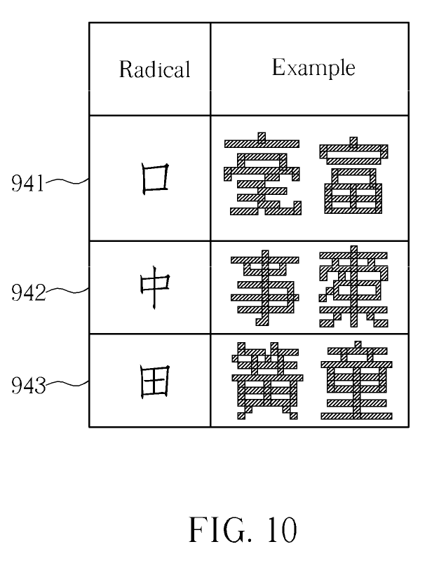

Please refer to FIG. 10. FIG. 10 is a diagram illustrating an exemplary embodiment of the stroke-simplifying rule. The present invention supplements the stroke data of a font with the simple fine-tune information, so when the font engine generates the font, the font engine can adjust/fine-tune the position and the size of each stroke of the font according to the fine-tune information, wherein the fine-tune information stores the available fine-tune instructions of the font. However, the font has to be in compliance with the stroke-simplifying rule, to be eligible to utilize the fine-tune instructions such as “merge” (combines two strokes) and “delete” (delete a stroke). As shown in FIG. 10, three radicals 941, 942, and 943 are all in compliance with the stroke-simplifying rule. If the font comprises the radical 941, the downside horizontal stroke of the radical 941 is combined with the lower adjacent horizontal stroke to become one stroke. If the font comprises the radical 942, the upside horizontal stroke of the radical 942 is combined with an upper adjacent horizontal stroke to become one stroke or, the downside horizontal stroke of the radical 942 is combined with a lower adjacent horizontal stroke to become one stroke. If the font comprises the radical 943, the upside horizontal stroke of the radical 943 is combined with the an adjacent upper horizontal stroke to become one stroke, or, the downside horizontal stroke of the radical 943 is combined with an adjacent lower horizontal stroke to become one stroke.

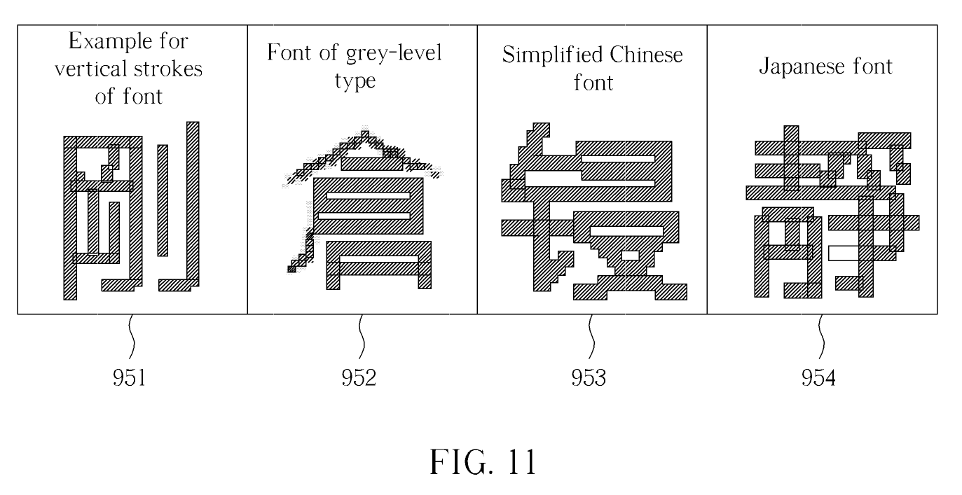

Please refer to FIG. 11. FIG. 11 is a diagram illustrating various types of fonts. In above-mentioned embodiments, the method for adjusting the horizontal strokes of the font, for example, the font 500, of the present invention, is also applicable to adjust vertical strokes of a font such as the font 951, as shown in FIG. 11. The method for adjusting strokes of a font of the present invention can calculate the insufficient space units for the vertical strokes as well as the horizontal strokes according to the stroke data of the font, the space distribution for the vertical strokes of the font are fine-tuned according to the insufficient space units of the vertical strokes (i.e. in the horizontal direction), and adjusts the space distribution for the horizontal strokes of the font according to the insufficient space units of the horizontal strokes (i.e. in the vertical direction). Furthermore, the font of grey-level type or other typefaces is also applicable to be fine-tuned by the method of the present invention. For example, the grey-level effect is only applied to the strokes that are neither vertical nor horizontal of the font 952 of the grey-level type, and therefore, the method of the present invention is still applicable for fonts of grey-level type (i.e. font 952) by assuming that the vertical or the horizontal stroke is of a corresponding single grey level. Additionally, the method of the present invention is also applicable to other language systems such as the simplified Chinese font 953 and the Japanese font 954.

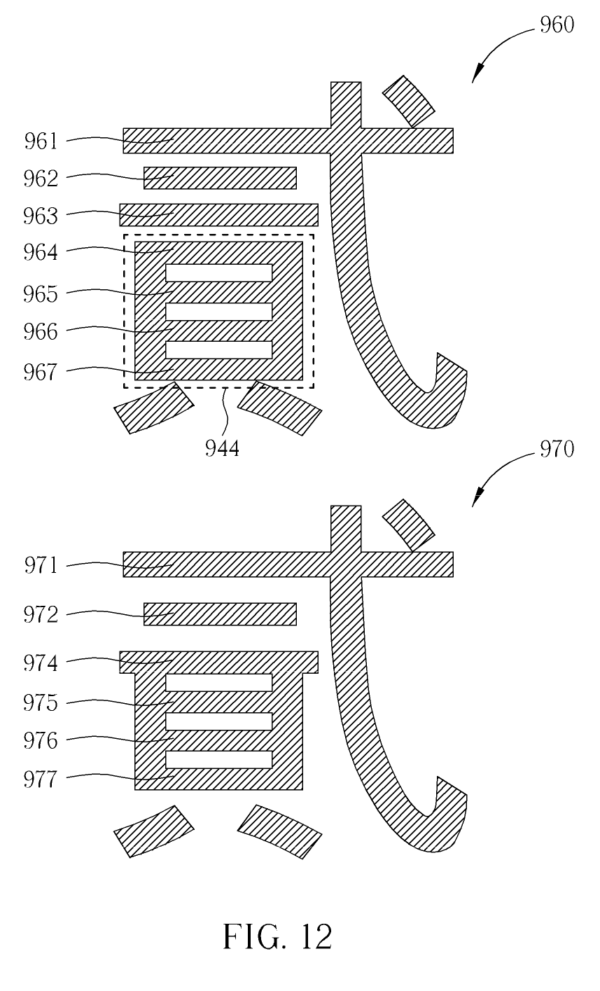

Please refer to FIG. 12. FIG. 12 is a diagram illustrating the method for adjusting strokes of a font of the present invention when the font is defined as a non-stroke-composition font. As shown in FIG. 12, the font 960 is defined as a non-stroke-composition font, more particularly; the font 960 is formed by a number of closed loop contours. However, the font engine can still easily recognize the seven horizontal strokes 961 to 967 of the font 960. According to the stroke-simplifying rule, if the font comprises a radical 944, the upside horizontal stroke of the radical 944 can be combined with an upper adjacent horizontal stroke, or the downside horizontal stroke of the radical 944 can be combined with a lower adjacent horizontal stroke, or the second horizontal stroke in the radical 944 can be deleted and the first horizontal stroke is moved to the middle of the radical 944. Therefore, in a preferred embodiment of when the font 960 of non-stroke-composition type is scaled to be the font 970, the font engine firstly determines the seven horizontal strokes 961 to 967 of the font 960, and then the fine-tune instruction “merge” is used to combine the strokes 963 and 964 to be the horizontal stroke 974 according to the stroke-simplifying rule, and the optimum space distribution for the six horizontal strokes 971 to 977 is then calculated for generating the font 970.

To sum up, the present invention provides a method for adjusting strokes of a font for avoiding the stroke clusters occurring after the font is scaled. When a font is generated, a font engine calculates the insufficient space units between each two adjacent strokes of the font according to the stroke data of the font, then obtains the fine-tune information of the font for calculating the optimum space distribution according to the insufficient space units and the fine-tune information so as to generate the stroke-tuning values of the font, and finally outputs the font according to the stroke data and the stroke-tuning values. When a font is defined as a stroke-composition type, the method for fine-tuning strokes of the font of the present invention adds simple stroke-tuning values for generating a font with high visual quality. Further, when a font is defined as a non-stroke-composition type, the method of fine-tuning strokes of the font of the present invention determines the horizontal and the vertical strokes and fine-tunes the positions of the horizontal and the vertical strokes of the character accordingly to raise the level of visual quality of the font.

Those skilled in the art will readily observe that numerous modifications and alterations of the device and method may be made while retaining the teachings of the invention.

What is claimed is:

1. A method for fine-tuning strokes of a font, the method comprising:
providing stroke data of the font;
calculating insufficient space between two adjacent strokes of the font according to the stroke data;
obtaining fine-tune information of the font;
calculating optimum space distribution according to the insufficient space and the fine-tune information for generating stroke-tuning values of the font; and
outputting the font according to the stroke data and the stroke-tuning values.

2. The method of claim 1, wherein providing the stroke data of the font comprises:
providing a stroke ID of each stroke of the font; and
providing a start position of each stroke of the font.

3. The method of claim 1, wherein calculating the insufficient space between the two adjacent strokes of the font according to the stroke data comprises calculating the insufficient space for a first direction and a second direction between the two adjacent strokes of the font according to the stroke data.

4. The method of claim 1, wherein the fine-tune information comprises a fine-tune instruction.

5. The method of claim 4, wherein the fine-tune instruction comprises combining two strokes, moving down a stroke, moving up a stroke, and deleting a stroke.

6. The method of claim 1, further comprising:
determining if an overlapped part of the two adjacent strokes is higher than a predetermined value.

7. The method of claim 6, further comprising:
when the overlapped part is higher than the predetermined value, processing fine-tune information of the two adjacent strokes together.

8. The method of claim 6, further comprising:
when the overlapped part is not higher than the predetermined value, processing fine-tune information of the two adjacent strokes separately.

9. The method of claim 1, further comprising:
adding the fine-tune information to the stroke data of the font.

10. The method of claim 9, wherein adding the fine-tune information to the stroke data of the font comprises adding the fine-tune information to the stroke data of the font according to a stroke-simplifying rule.

11. The method of claim 9, wherein obtaining the fine-tune information of the font comprises obtaining the fine-tune information of the font from the stroke data of the font.

12. The method of claim 1, wherein providing the stroke data of the font comprises providing the stroke data of a font of grey-level type.

13. The method of claim 1, wherein providing the stroke data of the font comprises providing the stroke data of a font of a traditional Chinese font, a simplified Chinese font, or a Japanese font.
